(19) United States
(12) Patent Application Publication
(10) Pub. No.: US 2023/0408226 A1
(43) Pub. Date: Dec. 21, 2023

(54) Ballistic Protection System and Method of Use

(71) Applicants: Maximus J Giordano, Rumney, NH (US); Cindy-Lou M. Simmons, Rumney, NH (US)

(72) Inventors: Maximus J Giordano, Rumney, NH (US); Cindy-Lou M. Simmons, Rumney, NH (US)

(21) Appl. No.: 18/336,673

(22) Filed: Jun. 16, 2023

Related U.S. Application Data
(60) Provisional application No. 63/403,933, filed on Sep. 6, 2022.
(60) Provisional application No. 63/352,876, filed on Jun. 16, 2022.

(51) Int. Cl. F41H 5/013; F41H 5/24; E04B 1/344; G08B 21/10

(52) U.S. Cl. CPC F41H 5/013; F41H 5/24; E04B 1/3445; G08B 21/10

(57) ABSTRACT

A comprehensive bulletproof protective system can include a method for enhancing the safety of students and staff during shooting incidents within a classroom setting. The system can include a bulletproof partition, which can include a single panel or a series of interconnected panels, and can be fixed in place or can be deployed in a rolling or sliding manner. The partition can extend from the ceiling to the floor of the classroom, utilizing a track on the floor and a ceiling track for its movement. Additionally, a remote monitoring system can be included, capable of automatically activating the partition upon detecting a shooter, as determined by one or more cameras monitoring the outside of the school. The partition functions to create a safety chamber, shielding occupants from harm by covering walls, doorways, and/or windows.

### RELATED APPLICATIONS

This application claims the benefit of U.S. Provisional Application Ser. No. 63/352,876, filed Jun. 16, 2022, entitled PROJECT SAFE HAVEN, and claims the benefit of U.S. Provisional Application Ser. No. 63/403,933, filed Sep. 6, 2022, entitled PROJECT SAFE HAVEN, the entire disclosures of which are herein incorporated by reference.

### FIELD OF THE INVENTION

The present invention generally relates to the field of bulletproof protective systems. More specifically, the present invention relates to a novel bulletproof protective system designed to be installed in individual rooms such as classrooms within a school or other rooms within a building.

### BACKGROUND OF THE INVENTION

By way of background, a school shooting refers to an event in which an armed attacker enters an educational institution, such as a primary school, secondary school, high school, or university, with the intention of causing harm and potentially taking lives of students, teachers, and other people. Frequent shooting attacks pose a severe threat to the safety and well-being of students and teachers. Generally, the attackers use firearms or other weapons to carry out the attack.

For protection in event of a shooting, the immediate means of protection is to hide under a desk. However, desks neither effectively conceal a student nor provide effective ballistic protection. This means of protection is ineffective and may not be able to prevent casualties during an active shooting situation.

To solve the problem of safeguarding students and staff during shootings, some schools have employed security personnel or even armed guards to provide an immediate response in the event of an attack. Many educational institutions struggle with limited budgets, making it difficult to implement comprehensive security measures across all schools.

Therefore, there is a need for a bulletproof protective system to protect individual classrooms. There is also a long felt need for an improved way of protecting students and staff by providing them a safety chamber during shooting events. Further, there is a long felt need in the art for a bulletproof protective system that eliminates the need to hide under a desk in the face of an armed assailant.

### SUMMARY OF THE INVENTION

This invention overcomes disadvantages of the prior art by providing a bulletproof system for providing a safety chamber for students and staff in case of a school shooting. The system can be designed to be installed in classrooms of different sizes without occupying much space. Furthermore, the system can be used for covering one or more walls, doors and windows of a classroom. Although the description herein refers to schools and classrooms, it should be clear that the present disclosure can also apply to office buildings, post offices, and various other buildings and various types of rooms that may be subject to attack by an armed assailant.

This invention can also overcome disadvantages of the prior art by providing a bulletproof protection system. The system can include a bulletproof shield, also referred to herein as a bullet proof partition, or simply a partition, installed in a classroom. In various embodiments, the partition can include a plurality of interconnected panels, the partition can be rolling or sliding, or the partition can be fixed in place. The partition can extend from the ceiling to floor of the classroom, and the ceiling and/or the floor can have a track for movement of the partition. A remote monitoring system can be designed to automatically activate the bulletproof partition(s) to cover a wall and/or window of the classroom on detecting a shooter, wherein the bulletproof partition forms a safety chamber for students and staff or other occupants. The shooter can be detected using one or more cameras positioned outside of the school monitoring individuals approaching the school and/or in one or more classrooms.

In various embodiments, a mobile ballistic partition system for deployment in a school or other building can include at least one mobile ballistic panel, at least one roller on the mobile ballistic panel, at least one locking mechanism configured to selectively lock the mobile ballistic panel to a wall or floor to secure the mobile ballistic panel in a deployed position, thereby creating an enclosed safety chamber within a room. The mobile ballistic partition system can include at least one track that is in a fixed location within a room, the at least one track defining the area of the safety chamber, wherein the roller on the at least one mobile ballistic panel can travel along the track so that the mobile ballistic panel defines the enclosed safety chamber. The at least one track can be inset into the floor a predetermined distance, so that the bottom edge of the mobile ballistic partition is below the floor surface thereby creating a safety chamber that is free from gaps between the mobile ballistic partition and the ceiling that would allow a shooter to shoot into the safety chamber. The at least one partition can include a kickplate at the bottom of the partition, the kickplate extending out from the partition to cover the track that is inset into the floor, the kickplate configured to deflect bullets so that bullets cannot be shot at the rollers or the track. The at least one track can be an overhead rail that is inset into the ceiling a predetermined distance, so that the top edge of the mobile ballistic partition is above the ceiling thereby creating a safety chamber that is free from gaps between the mobile ballistic partition and the ceiling that would allow a shooter to shoot into the safety chamber. The overhead rail can include a bulwark, the bulwark extending from above the rail and the at least one roller to below the rail and the at least one roller, and the bulwark extending to less than an inch from the mobile ballistic partition when the mobile ballistic partition is in a deployed conformation. The at least one roller can include a height adjustor, wherein when the height adjustor is in an extended conformation the roller at least partially extends below the bottom of the mobile ballistic panel so that the mobile ballistic panel can be moved into a deployed position, and wherein when the height adjustor is in a retracted conformation the roller does not extend below the bottom of the mobile ballistic panel so that the bottom of the mobile ballistic panel rests on the floor. The at least one mobile ballistic panel can include a plurality of mobile ballistic panels that are arranged in a row, and wherein the mobile ballistic partition further comprises hinges between adjacent panels so that two neighboring panels can pivot relative to each other, wherein the mobile ballistic partition that comprises a plurality of mobile ballistic panels can be deployed along the track to create a protective wall that defines a safety chamber. At least one of the plurality of mobile ballistic panels can have a seam overlap flap at one end of the panel, and a notch at the other end of the panel, so that when the panels pivot relative to each other to form a wall, the seam overlap flap of one panel will lay in the notch of the neighboring panel, so that the seam overlap flap creates a ballistic protection for the hinges between panels. The at least one mobile ballistic panel can include at least two mobile ballistic panels, wherein the two mobile ballistic panels are hinged to one or more walls of a room at proximal ends of the mobile ballistic panels, and wherein the mobile ballistic panels are hinged to the one or more walls of the room at fixed locations that are remote from each other, and wherein the two mobile panels can be stored along one or more walls in the stored conformation, and wherein the two mobile panels can be hingedly pivoted out from the walls, and wherein the mobile ballistic panels can meet at distal ends of the panels to form a safety chamber with mobile panels forming at least two walls of a safety chamber, the safety chamber including at least one wall of the building as a wall of the safety chamber.

In an embodiment, a system for preserving human life during an armed attack can include at least one camera facing an outside of a building, at least one monitor monitoring a video stream from the camera, at least one mobile ballistic partition within the building, the mobile ballistic partition stored in a stored conformation, at least one automatic partition mover operatively connected to the at least one mobile ballistic partition, wherein the at least one mobile ballistic partition is automatically moved to an at least partially deployed conformation by the automatic partition mover in response to an action signal from the monitor. The system for preserving human life can include at least one overhead rail to support the at least one mobile ballistic partition, wherein the at least one mobile ballistic partition further comprises at least one roller that rolls on the overhead rail to carry the mobile ballistic partition, and wherein the at least one overhead rail further comprises a bulwark to shield the rail, the roller, and the top of the partition from bullets. The system for preserving human life can include at least one lower track that is inset into the floor, wherein the at least one mobile ballistic partition further comprises at least one roller that rolls on the lower track to carry the mobile ballistic partition, wherein the bottom edge of the mobile ballistic partition is below the floor surface so that there are no gaps to allow a shooter to shoot into the safety chamber. The at least one mobile ballistic partition can be concealed behind a false wall when the at least one mobile ballistic partition is in a stored position, and wherein when the at least one automatic partition mover automatically moves the at least one mobile ballistic partition in response to an action signal, the at least one mobile ballistic partition is at least partially exposed by pushing the at least one mobile ballistic partition out from behind the false wall so that it can be grabbed by a person and fully deployed manually.

In an embodiment, a method of preserving human life can include monitoring the outside of a building, perceiving a threatening individual approaching the building, sending an action signal to the threatened building, alerting occupants of the building to the threat in response to the action signal, and automatically moving automatic parts of a ballistic protection system in response to the action signal. Automatically moving automatic parts of the ballistic protection system in response to the signal can include moving parts of the ballistic protection system to form a safety chamber, the safety chamber configured to provide a ballistic shelter to preserve the lives of the occupants of the safety chamber.

### BRIEF DESCRIPTION OF THE DRAWINGS

The invention description below refers to the accompanying drawings, of which:

FIG. 1A is a perspective view of bulletproof protective system for installation in a classroom, school, or other building that may be subject to an armed attack, according to an illustrative embodiment;

FIG. 1B is a top view of a portion of the partition in FIG. 1A, according to an illustrative embodiment;

FIG. 2 is a top view of another embodiment of a hinged sliding partition used in a bulletproof protection system, according to an illustrative embodiment;

FIG. 3 is a perspective view of two back-to-back classrooms with a permanently installed bulletproof protection system, according to an illustrative embodiment;

FIG. 4 is a front view of the bulletproof partition shown in FIG. 3, according to an illustrative embodiment;

FIG. 5 is an inside view of the bulletproof protection system in the form of a sliding partition, according to an illustrative embodiment;

FIG. 6 is a schematic view of a roller for use with a floor track of a mobile bulletproof protection system, according to an illustrative embodiment;

FIG. 7 is a schematic view of a roller for use with a ceiling track system for a mobile bulletproof protection system, according to an illustrative embodiment;

FIG. 8A is an end view of a partition with swivel castors and height adjustors for moving and placing the bulletproof partition, with the height adjustor in an extended conformation, according to an illustrative embodiment;

FIG. 8B is an end view of a partition with swivel castors and height adjustors for moving and placing the bulletproof partition, with the height adjustor in a retracted conformation, according to an illustrative embodiment;

FIG. 9 is a top view showing a bulletproof protection system with pivotable panels to form a collapsible pop-out shelter, according to an illustrative embodiment;

FIG. 10A is a top view of a series of armor plates deployed through a track system to create a bulletproof protection partition, according to an illustrative embodiment;

FIG. 10B is a front view of the series of armor plates of FIG. 10A in a deployed arrangement, according to an illustrative embodiment;

FIG. 10C is a schematic view of a partition formed from bulletproof panels that are hinged together, according to an illustrative embodiment.

FIG. 11 is a top view showing a bulletproof partition designed to roll and unroll for deployment, according to an illustrative embodiment;

FIG. 12 is a perspective view of a partition that can be stored overhead in ceiling of a classroom, according to an illustrative embodiment;

FIG. 13 is an end view showing a slidable partition with ballistic protection for the rails and wheels of the partition, according to an illustrative embodiment;

FIG. 14 is an inside view of a security system using a bulletproof partition for securing occupants of a room, according to an illustrative embodiment;

FIG. 15 is an end view of bottom track set into the floor, according to an illustrative embodiment;

FIG. 16A is an interior view of a protection system for the classroom windows, according to an illustrative embodiment;

FIG. 16B is a schematic end view of the top portion of a sliding partition for windows, according to an illustrative embodiment;

FIG. 16C is a schematic end view of a bottom portion of a sliding partition and track, according to an illustrative embodiment;

FIG. 16D is an interior view of a stackable panel, according to an illustrative embodiment;

FIG. 16E is a top view of the stackable panels of FIG. 16D, according to an illustrative embodiment;

FIG. 17A is a partially cut away perspective view showing rollers riding within an enclosed overhead tube-type rail another variant of the ballistic protection, according to an illustrative embodiment;

FIG. 17B is a partially cut away view showing rollers riding on a T-type or I-beam-type rail according to an illustrative embodiment;

FIG. 18 is a perspective view from within the safety chamber showing inner locking mechanisms to secure the mobile partition in a desired location, according to an illustrative embodiment;

FIG. 19A is a top view showing the layout of a classroom with a mobile bulletproof partition designed to slide on floor track and ceiling track, according to an illustrative embodiment;

FIG. 19B is a top view showing the layout of a classroom with a mobile bulletproof partition in a partially deployed position, according to an illustrative embodiment;

FIG. 19C is a top view showing the layout of a classroom with a mobile bulletproof partition creating a reduced-space safety chamber in a subset of the classroom, according to an illustrative embodiment;

FIG. 20A is a top view showing the layout of a classroom with a mobile bulletproof partition stored at the front of the classroom, according to an illustrative embodiment;

FIG. 20B is a top view showing the layout of a classroom with a mobile bulletproof partition in a deployed position, according to an illustrative embodiment;

FIG. 20C is a top view showing the layout of a classroom with a mobile bulletproof partition in a deployed position with a ballistic classroom door, according to an illustrative embodiment;

FIG. 21 is a schematic view of a security room for the bulletproof protection system;

FIG. 22 is a flow chart showing a method of protecting a school or other building, according to an illustrative embodiment; and

FIG. 23 is a schematic overview of a processing and control system for an automatic threat detection and ballistic protection system, according to an illustrative embodiment.

### DETAILED DESCRIPTION

There are a great many possible implementations of the invention, too many to describe herein. Some possible implementations are described below. In the following description, for purposes of explanation, numerous specific details are set forth in order to provide a thorough understanding thereof. It should be clear, however, that the innovation can be practiced without various specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, any particular embodiment need not have all the aspects or advantages described herein. Thus, in various embodiments, any of the features described herein from different embodiments may be combined. It cannot be emphasized too strongly, however, that these are descriptions of implementations of the invention, and not descriptions of the invention, which is not limited to the detailed implementations described in this section but is described in broader terms in the claims.

A bulletproof protective system can be installed for use in various buildings, including schools, office buildings, post offices, shopping malls, and more. As described herein, terms such as bulletproof protective system and ballistic protective system can be used interchangeably, and no differentiation is intended between the terms ballistic and bulletproof. The system described herein is designed to protect occupants of a building from a shooting attack, and the system is referred to as bulletproof and/or ballistic protection. In various embodiments, a bulletproof protective system can create a bulletproof safety chamber, also referred to as a safety chamber, in a classroom or other room. In various embodiments, the bulletproof protective system can turn the entire room into a safety chamber, or can create a reduced-space safety chamber in a subset of the room. A bulletproof partition can be stored in a stored conformation that takes up minimal space within the room, and can be moved to a deployed conformation to create a protective safety chamber. By way of non-limiting example, in various embodiments, the stored conformation for the bulletproof partition can include a folded conformation, a rolled conformation, a stacked conformation, and/or can include being in a storage location on a track that allows the partition to be moved to a deployed location. In various embodiments, a partition can be deployed automatically, or can be deployed manually, or the deployment can start automatically and can be completed manually.

In various embodiments such as a shopping mall, a bulletproof partition can be deployed across the entrance to the store so that the entire store can become a safety chamber, safe from an attacker who may attack from the interior, or hallway area of the mall. Similarly, in various classroom applications, a bulletproof partition can be deployed across the entrance to the classroom, so that the entire classroom can become a safety chamber, safe from an attacker who may attack from the interior, or hallway area of the school. In various embodiments, a bulletproof partition can be deployed to form a reduced space safety chamber in a portion of a classroom, office room, store, etc. Many of the embodiments herein are described in the context of a school and a classroom, however, it should be clear that the ideas disclosed herein are applicable to a wide range of environments and are not intended to be limited to schools.

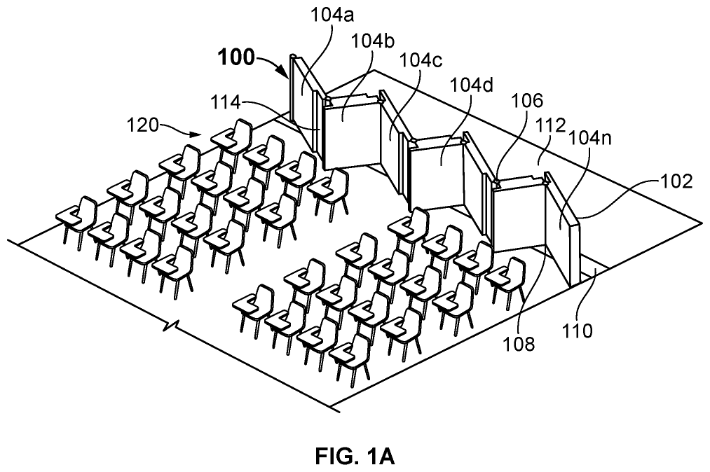

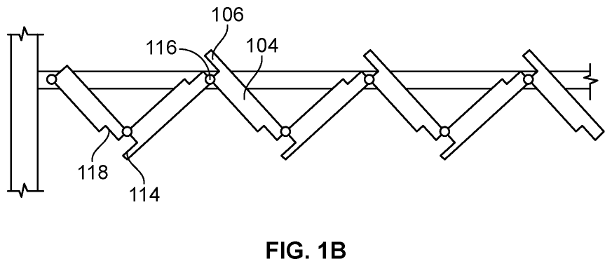

FIG. 1A is a perspective view of bulletproof protective system for installation in a classroom, school, or other building that may be subjected to an armed attack, according to an illustrative embodiment. The bulletproof protective system as shown in FIG. 1A can provide a reduced-space safety chamber 112 in the back of the room. The bulletproof protective system 100 can include a foldable bulletproof partition 102 designed like an accordion style wall. The partition 102 can include a plurality of interconnected panels 104a-n (hereinafter referred to as panels 104). The individual panels 104 are interconnected allowing a user to retract or extend the foldable partition 102. The consecutive panels can be connected to the ceiling at the top end 106 and/or the floor at the bottom end 108. The panels 104 can fold similar to an accordion or a fan in order to collapse the foldable, deployable partition out of the way. The partition can be stored in a folded conformation to minimize space taken up by the partition and to reduce impact on the footprint of the room, and the partition can be quickly deployed in a deployed conformation to create a ballistically protected safety chamber in at least a portion of the room. In the deployed conformation, the partition can form a protective wall with a width that takes up minimal space in the footprint of a small room. In various embodiments, the protective wall can be less than 12 inches thick, so that it takes up less than 12 inches of the space in the room. In various embodiments, the protective wall can be less than 6 inches thick, so that it takes up less than 12 inches of the space in the room.

The individual panels 104 of the bulletproof partition 102 can be designed to move along a track system 110 wherein the track 110 is embedded in the floor of the classroom 120, providing a secure and stable path for the partition's movement. The track 110 is preferably inset into the floor, by recessing or lowering, by a specific distance (e.g., 5 inches) to ensure complete protection and smooth movement of the partition 102. Track 110 is a single-wide track, with all panels riding on the same single track. This single-track design allows for the track 110 to use the smallest possible amount of floor space. Additionally, in various embodiments, there can be a corresponding upper track, also referred to as a rail, in the ceiling of the classroom wherein the upper rail can also be inset into the space above the ceiling (e.g., 8 inches), to stabilize the partition 102 during movement thereof. Having the track extend to the ceiling or above the ceiling allows the partition to extend to the ceiling or above the ceiling, which increases the ballistic protection by limiting a shooter's ability to shoot over the top of the partition. An upper track, if present, is also a single-wide track, with all panels riding on the same track. Various embodiments can have only a floor track, only a ceiling track, or a combination of floor track and ceiling track. Throughout this document, floor tracks and/or ceiling tracks in various embodiments can have the advantage of being single-wide tracks, with all panels riding on a single-wide track. However, it should be clear that referring to them as single tracks does not preclude embodiments having both, a single-wide track in the ceiling and a single-wide track in the floor. Many embodiments will have a single track in the ceiling and another single track in the floor, with all panels riding on, or between the upper and lower tracks.

The upper and/or lower tracks can carry the partition to make the partition easier for a child to move. Having the tracks inset into the floor and ceiling can increase the ballistic protection offered by the partition by allowing the partition to extend completely from floor to ceiling with no gaps at the top or bottom of the partition. The partition can create a safety chamber that is free from gaps between the panel and the floor, free from gaps between the panel and the ceiling, and/or free from gaps between the panels and the walls of the room.

In a fully deployed conformation, the partition can be approximately in the shape of a straight line, and in embodiments with a floor track 110, the partition can be positioned substantially over the floor track. The partition 102 can have overlapping seam overlap flaps 114 at each joint section where the panels 104 of the bulletproof partition 102 fold. The seam overlap flaps 114 are designed to provide additional protection by covering the gaps between the panels 104 when the bulletproof partition 102 is fully deployed. The seam overlap flaps allow the partition to provide seamless coverage from wall to wall with no gaps to be exploited by an attacker.

FIG. 1B is a top view of a portion of the partition in FIG. 1A, according to an illustrative embodiment. The seam overlap flaps 114 minimize the chances of projectiles or attacks penetrating through the joints. The seam overlap flaps 114 enhance the overall defensive capabilities of the partition 102. As the partition is extended into the fully deployed conformation, an individual panel can pivot relative to a neighboring panel at hinge 116. In the fully deployed conformation, the seam overlap flaps 114 of one panel can be engaged in the nearby notch 118 of the neighboring panel. With the flap 114 of one panel laying in the notch 118 of the next panel, the entire partition 102 creates a barrier with an extra layer protecting the hinges thereby increasing the resistance to bullets. The partitions described herein can provide seamless coverage from wall to wall and from floor to ceiling to protect the occupants, free from gaps, seams, or other openings that could be exploited by an attacker.

In various embodiments, the bulletproof partition can be operated manually and/or can also be deployed automatically. Automatically deployed bulletproof partitions can be deployed through the use of magnets, chain drives, screw drives, rack gears, or other mechanical means. Automatically deployed bulletproof partitions can be deployed in response to a signal indicating an incoming threat. In various embodiments, the bulletproof partition can be made of any conventional bulletproof material, including combinations of ballistic materials, such as steel, liquid armor, ballistic gels, bullet proof glass, fiberglass, Kevlar, and others.

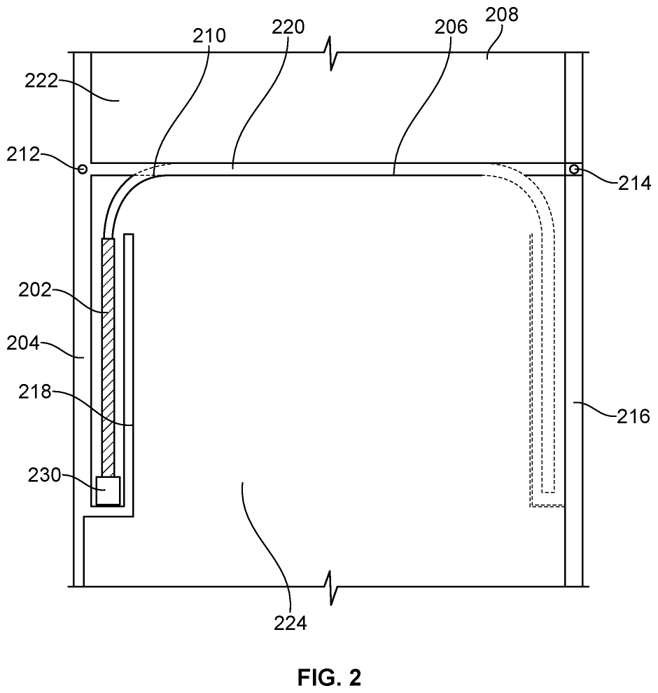

FIG. 2 is a top view of another embodiment of a hinged sliding partition used in a bulletproof protection system, according to an illustrative embodiment. In various embodiments, the hinged sliding partition can be stored along one wall, and can be deployed along track(s) from the stored position to a deployed position in a different location. In various embodiments, the partition can be stored in a pocket along one or more walls, and can be slid out from the pocket into a deployed position by sliding the partition along track(s) in the floor and/or ceiling.

The partition 202 can be hinged and can be stored on a track along one or more walls 204, 216 of a classroom 224. As illustrated, the partition 202 is stored along the left wall 204. The partition 202 is designed to slide along a track system 206, enabling the partition 202 to move from the stored position (along the wall 204) to a deployed position 220. In various embodiments where wall 208 is a solid wall, such as an interior wall made from brick, cinderblock, or other bullet-resistant materials, the partition can form a safety chamber 222 between the wall 208 and the partition 202 on the track 206. In various embodiments where wall 208 might be a “soft” wall that could include a doorway, windows, and/or non-bullet-resistant materials, the partition 202 can be deployed along the track 206 to cover the soft wall so that the rest of the classroom can become a safety chamber.

The sliding partition 202 can include rollers with frictionless bearings, so that the rollers can roll easily on the track, thereby enabling even a child to move the heavy partition from the stored position (such as along the wall 204) to the deployed position 220 easily without applying much force. The rollers can be any conventional rollers, including so-called idler rollers, drive rollers, and others. The rollers allow the partition to move on the upper and/or lower tracks with minimal friction and allow for smooth sliding of the partition along the track system 206.

The track system 206 can be in a U-shape extending along three sides, or can be in an L-shape extending along two sides. In various embodiments, the partition can be a single partition stored along one wall, or can be two partition components stored along two walls. Embodiments with two partition components can include a first partition component stored along a first wall, such as wall 204, and a second partition component stored along a second wall such as 216. The two partition components can be deployed along the track so that they meet in the deployed position 206 and can be locked in place abutting each other. In embodiments with a single partition, the partition can include a switch junction that allows the partition to be stored and deployed along one track and then have a portion of the partition switched to a deployment track portion, explained more fully below.

In embodiments with a single partition, the partition can be slid past a switch junction 210 in the track system 206, and can then be moved in reverse (towards the wall 204 along the track system 206) to engage the lock 212. The lock 212 can secure the partition 202 in the deployed position. In various embodiments, the lock can be inset into wall 204 so that the partition can nest into the wall. This inset position can provide additional protection by reducing any potential gaps.

In various embodiments, an additional stub wall partition segment can be fixed in place or hinged to deploy to cover any gap that remains after the partition is moved in reverse through the switch junction to engage lock 212. In various embodiments, the partition 202 can be designed to have accordion or fan folding capabilities. The partition 202 can be fold in a manner similar to an accordion or a fan, allowing a trailing end of the partition 202 to slide past the switch junction 210. The leading edge of the partition can be engaged with the lock 214 and the trailing edge can slide past the switch junction and then extend to engage with lock 212. The opposite ends of the partition 202 can be locked into the inset locking mechanisms 212, 214 located in the walls 204, 216.

In various embodiments with two partition components, the partition 202 can be divided into two portions wherein one portion can be stored along the wall 204, while the other portion is stored along the wall 216. When deployed, both portions can be moved along the floor track system 206 and the two portions of the partition 202 can be locked together at the middle of the track system 206. The dual-half configuration can provide extended coverage and reinforces the partition's protective capabilities. The partition 202 can form a safe enclosed between the partition 202 and a bullet-resistant wall 208 (at the top of FIG. 2) for accommodating students and staff during a shooting event, or the partition can cover a soft wall 208 to form a safety chamber within the classroom. A portion of the track system 206 can be designed to be hidden in a pocket that can be formed by a pocket wall 218 that can also have a blackboard, shelves and the like along the opposite walls 204, 216.

In various embodiments, a mobile partition system can include an automatic partition mover 230. The automatic partition mover 230 can move the partition from a stored position to a deployed position or a partially deployed position. The automatic partition mover can include a piston, magnets, screw drive, chain drive, or other various means for moving the partition. Upon receiving an action signal indicating an incoming threat, the automatic partition mover can automatically move the partition into a deployed or partially deployed position quickly. In embodiments with the partition hidden behind a false wall, the automatic partition mover 230 can move the partition to a partially deployed position that is at least far enough so that a portion of the partition extends out from behind the false wall, so that a child can grab the partition and move the partition into a fully deployed position.

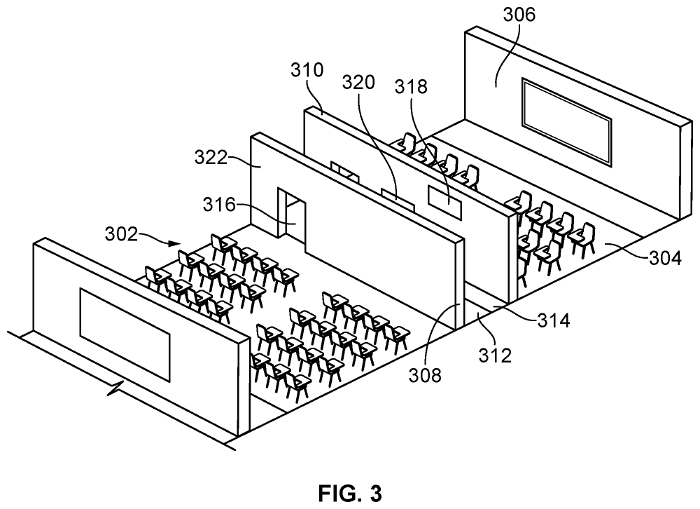

FIG. 3 is a perspective view of two back-to-back classrooms with a permanently installed bulletproof protection system, according to an illustrative embodiment. In various embodiments, a safety chamber can be constructed with a permanently installed reinforced shelter. As described herein, the permanently installed shelter means that at least a portion of the bulletproof shelter does not need to be moved into deployment, but instead remains in a fully deployed condition at all times. FIG. 3 depicts two classrooms 302, 304 positioned back-to-back with a shared safety chamber 314 positioned between the classrooms 302, 304. Safety chamber 314 can be formed from permanently installed bulletproof wall 322 of classroom 302, and permanently installed bulletproof wall 310 of classroom 304. In various embodiments, each classroom can have separate shelters, such as shelter 312 for classroom 302, and shelter 314 for classroom 304, with a classroom wall between them, or the two rooms can share a single shelter between the rooms. The shelters 312, 314 can serve as protected areas in the classrooms 302, 304 that can be quickly accessed in the event of an emergency, such as an active shooter situation. Occupants can then seal the shelter by closing a bulletproof door other mobile bulletproof partition over the door 316.

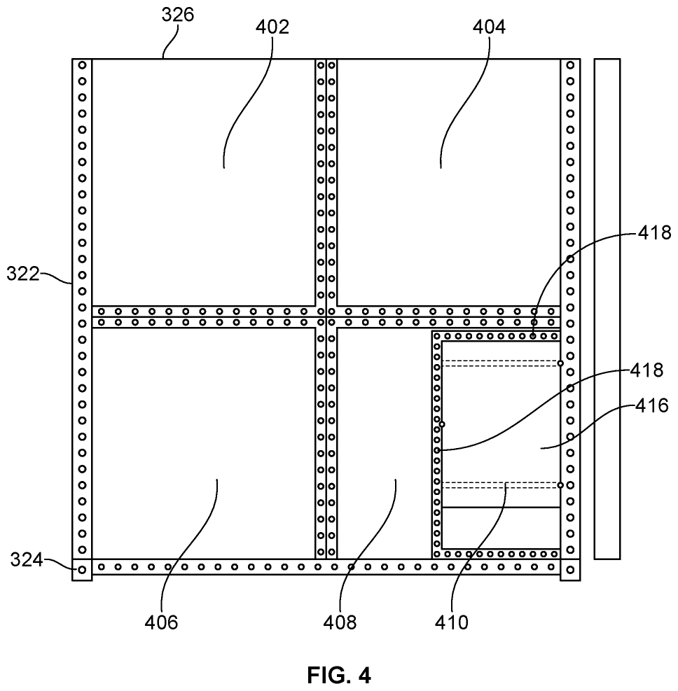

FIG. 4 is a front view of the bulletproof partition shown in FIG. 3, according to an illustrative embodiment. Turning now to FIGS. 3 and 4, mobile partition to seal the safety chamber 312 can be a hinged door 416 that can selectively provide access to, or seal the safety chamber. The door 316 can be designed with overlap joints as illustrated in FIG. 4, which are overlapping sections 418 that ensure maximum protection against external threats. The overlap joints enhance the overall strength and integrity of the door, minimizing the risk of bullets or projectiles penetrating the shelter.

In various embodiments, the reinforced shelters 312, 314 can be spacious enough to accommodate 50 or more students. The reinforced shelters 312, 314 can be designed to provide enough room for students and teachers to seek safety without compromising the overall footprint of the classroom. Various comforts can also be provided for the students within each shelter. Comforts can include one or more ventilation vents 318 for ensuring a fresh supply of air even when the shelters 312, 314 are sealed for security reasons. In various embodiments, ventilation vents 318 can be positioned on an exterior wall to vent to the outside. Additionally, a TV monitor 320 can be installed in each shelter, allowing students to see help arriving.

The bulletproof partition 322 can be constructed using various materials to ensure high levels of protection against bullets, projectiles and more. The bulletproof partition 322 can includes different panels 402, 404, 406, and 408 that can be made of one or more of bulletproof glass, Kevlar, steel, ballistic gels, or other protective materials. It should be appreciated that the specific combination of materials for forming the panels 402-408 can be adjusted based on the desired level of protection and design requirements.

The stationary bulletproof partition 322 includes doorway 316 and a mobile partition 416, which can be a hinged door, sliding door, rolling door, or other mans for covering the opening with a bullet-resistant partition that cannot be breached easily by a would-be attacker. For ensuring safety of occupants inside the shelter, the door 416 can have a handle on the rear part thereof allowing opening and closing of the door 416 only from the inside of the shelter 312. The absence of an exterior handle helps to prevent unauthorized access and ensures control over entering or exiting the shelter 312.

In embodiments with a hinged door, the hinged door 416 can be secured by barring or bracing 410 from the inside. This additional measure strengthens the door's resistance against external forces, preventing unauthorized access and increasing the level of protection. The exact method of barring or bracing the door 416 shut can vary based on the design and specific locking mechanisms.

The safe haven partition 322 can be bolted into the floor of the classroom using bolts 324, and the top edge 326 can extend above the ceiling of the classroom. By securely bolting the bottom of the partition 322 to the floor, the partition 322 is not displaced or compromised during an attack. The extension of the partition 322 above the ceiling provides added protection and prevents access from the top of the partition 322.

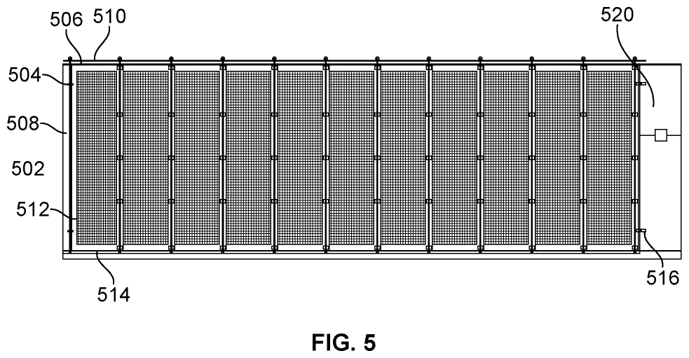

FIG. 5 is an inside view of a bulletproof protection system in the form of a sliding partition, according to an illustrative embodiment. The sliding partition can be stored in a first area and deployed into a deployed position to provide protection from an attacker. The sliding partition 500 includes a plurality of interconnected panels 502 wherein each panel can have top and bottom rollers for easy sliding. The panels 502 can include an armored steel frame 506, and can include various ballistic protective materials. A top track 510 and/or bottom track 514 can allow for easy movement and deployment of the panels 502. Armored steel hinge plates 512 can connect neighboring panels 502 together. Bottom track 514 can be embedded in floor of the classroom, and top track can be inset above the ceiling to provide full floor to ceiling coverage.

In various embodiments, one or more of the individual panels can lock to the floor with deadbolt-type locks that engage holes in the floor or floor track. In embodiments, a panel can include a spring-latching deadbolt 504 in the inside face of the terminal panel, so that when that terminal panel slides into place at the end of the track, the spring-loaded deadbolt(s) can slide into openings at the top and/or bottom to secure that panel in place.

In various embodiments, the leading panel can lock to a fixed wall at the end of the track using latches 516 that can be automatic latches. The fixed wall at the terminal end of the track can be a stub wall 520 that includes a ballistic panel making the stub wall bullet resistant, and/or the fixed wall at the first end of the track can be a stub wall 508 that includes a ballistic panel making the stub wall bullet resistant.

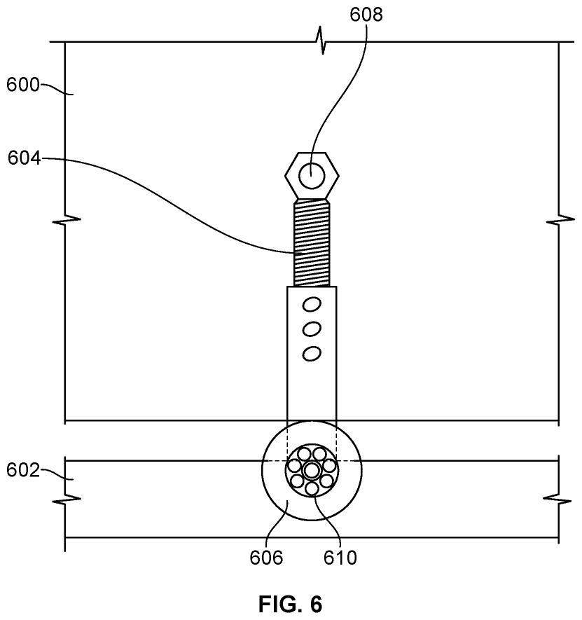

FIG. 6 is a schematic view of a roller for use with a floor track of a mobile bulletproof protection system, according to an illustrative embodiment. In various embodiments, floor track 602 can be designed to carry at least a portion of the weight of the partition 600, and the partition 600 can extend from the floor or below the floor to above the ceiling of a room. In various embodiments, partition panels can have a tension adjuster 604 that can adjust how much tension exists between the lower track and the upper track, also referred to as an upper rail. The tension adjuster 604 can adjust how freely the bulletproof partition moves by adjusting the tension in each panel between the upper and lower tracks. In various embodiments, the tension adjuster 604 may be within the panel, and an adjustment bolt 608 can be accessed from within the safety chamber to allow the tension to be adjusted. Roller 600 can ride on track 602, and bearings 610 within the roller can help to reduce friction and make the partition as easy as possible for a child to move the partition into a deployed conformation.

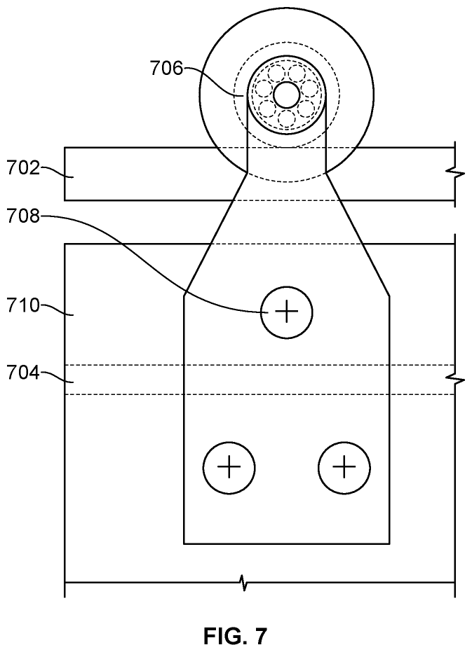

FIG. 7 is a schematic view of a roller for use with a ceiling track system for a mobile bulletproof protection system, according to an illustrative embodiment. The ceiling track 702 can be positioned above a ceiling 704. In various embodiments, the ceiling track can be disposed around 8″ inside the ceiling 704. The ceiling track 702 can be made of armored steel or other similar material. The ceiling track 702 has one or more rollers 706 that can ride on the upper track 702. The rollers 706 can move the partition 710 along the ceiling track 702. A plurality of armored steel rivets 708 can be used for securing the partition 710 to the rollers 706 that can be above the partition 710. The upper edge of the partition 710, along with the roller 706 and upper track 702 can all be located above the ceiling 704. This allows for complete ballistic protection for the children behind the partition all the way up to above the ceiling. The roller and floor track of FIG. 6 can support the bottom of a mobile panel, and the roller and upper track of FIG. 7 can support the top of the same mobile panel, and the tension adjuster can adjust the tension on the panel between the two tracks.

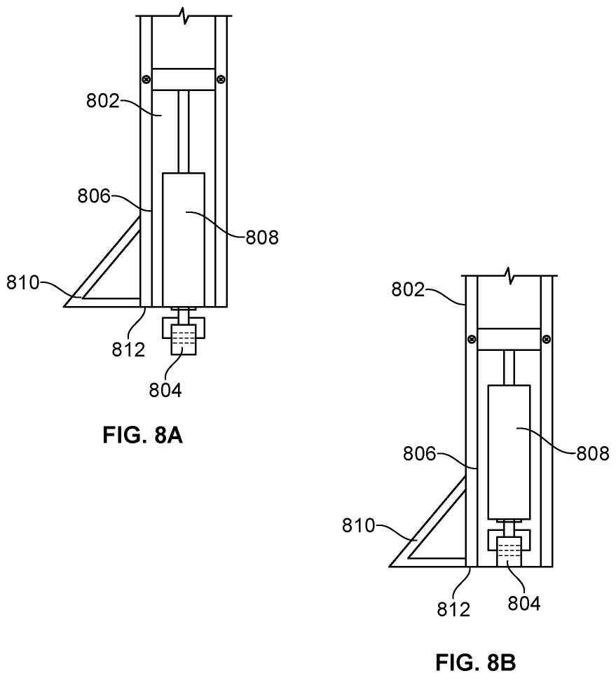

FIG. 8A is an end view of a partition with swivel castors and height adjustors for moving and placing the bulletproof partition, with the height adjustor in an extended conformation, according to an illustrative embodiment, and FIG. 8B is an end view of a partition with swivel castors and height adjustors for moving and placing the bulletproof partition, with the height adjustor in a retracted conformation, according to an illustrative embodiment. In various embodiments, a trackless bulletproof partition 802 can be deployed from a stored position to a deployed position without the need for a floor track or a ceiling track. The trackless partition 802 can have a plurality of rollers that can be swivel castors 804 which can be used for moving the partition 802 to create a safety chamber to protect people from an armed assailant. In various embodiments, a partition 802 can includes a plurality of interconnected partitions with each partition 806 having their own respective rollers that can be castors. The castors 804 provide a smooth movement on floor of a classroom or other room enabling users to quickly and easily deploy the partition 802 by simply pulling it across a room, over a doorway, over windows, or wherever a mobile ballistic partition is desired. Upon being deployed to the desired location, the partition can be locked to the floor and/or a fixed wall of the classroom, and in various embodiments, the lock can be inset within the wall to eliminate gaps and provide a safe and secure safety chamber for the occupants.

The partition 802 can include a height adjustor that can allow the partition to be elevated above, or on top of, the castor. In various embodiments, the height adjustor can be embedded within the partition, and in various embodiments, the height adjustor can be a piston 808 on top of each castor 804. In the extended conformation shown in FIG. 8A, the piston is extended so that the castor extends down below the bottom of the partition, thereby allowing the partition to move on the castors. In the retracted conformation shown in FIG. 8B, the piston is retracted so that the castor is drawn into the space within the partition and the partition can be lowered to the ground. In various embodiments, the partition can be resting completely on the ground with the castor entirely within the wall. In various embodiments, the castor can remain slightly extended to allow for placement and adjustment. Put another way, the piston 808 can be used for lowering the partition 802 over the castors 804, enabling a user to deploy the partition 802 with the piston in the extended conformation and then lower the partition to the floor in the deployed location to eliminate the gap between partition 802 and floor.

In various embodiments of a partition, a bulletproof kick plate 810 can extend outwards at an angle along the bottom 812 of the partition 802. The kick plate can be made from armored steel or other bulletproof materials. In embodiments without a height adjustor, a kick plate can extend out from the bottom of the partition to limit a shooter's ability to shoot bullets under the partition, at the track, etc. In embodiments with a floor track, the kick plate 810 can protect the track and rollers, and can prevent the shooter from shooting under the partition. In embodiments with a height adjustor, the partition can be lowered so that the kick plate rests on the floor, thereby preventing a shooter from being able to shoot at the bottom of the partition. The angle of the kickplate can deflect bullets to prevent bullets from entering the safety chamber or hitting the mechanical components of the partition such as pistons and castors or rollers and tracks. When the partition 802 is lowered to the floor, the kick plate 810 can rest on the ground or floor, thereby preventing a shooter from shooting at the seam where the partition 802 meets the floor. In various embodiments, the partitions of the partition 802 can be made of multiple layers of different bulletproof materials such as consecutive layers made of armored steel, ballistic glass, ballistic film, liquid armor and more.

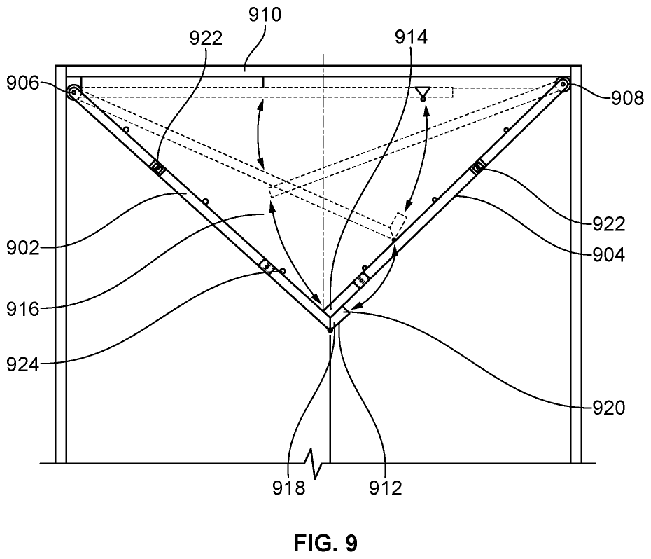

FIG. 9 is a top view showing a bulletproof protection system with pivotable panels to form a collapsible pop-out shelter, according to an illustrative embodiment. In the embodiment of FIG. 9, track systems are not required. As shown in FIG. 9, the system 900 can include two pivotable bulletproof panels 902, 904 designed to pivot from corners 906, 908 of a wall 910 of a classroom. The free ends 912, 914 of the panels 902, 904 respectively are designed to meet together, such as in the middle of the classroom, thereby forming a triangle-shaped shelter 916 formed by the panels 902, 904 and the wall 910.

The apex 918 can include an overlapping hook 920 allowing the panels 902, 904 to be quickly arranged in a nested conformation, and to be locked to each other safely with an overlap protecting the seam. Each panel can include a plurality of castors 922 for allowing movement of the panels 902, 904 along the floor of the classroom. In various embodiments, a plurality of locking rods 924 can be included as part of the panels 902, 904, and can be forced into holes in the floor to keep the panels 902, 904 stable and in place. In various embodiments, two panels such as panels 902 and 904 can be locked to each other where they meet.

In embodiments such as the one shown in FIG. 9 that have panels moving into position above the floor, a kickplate on the exterior of the wall can help to prevent a bullet from entering the safety chamber when a shooter shoots at the seam where the partition meets the floor, or is just above the floor. Although the embodiment of FIG. 9 is shown with two panels forming a triangle, it should be clear that in various embodiments a plurality of hinged panels, each hinged to the next, can be deployed to create various safety chambers of different sizes and shapes. The proximal end panels can remain hinged to the wall and can pivot outwards to form the shelter, while other hinged panels can each pivot relative to the neighboring panel to unfurl into a safety chamber that can remain hingedly mounted to the wall for strength and stability.

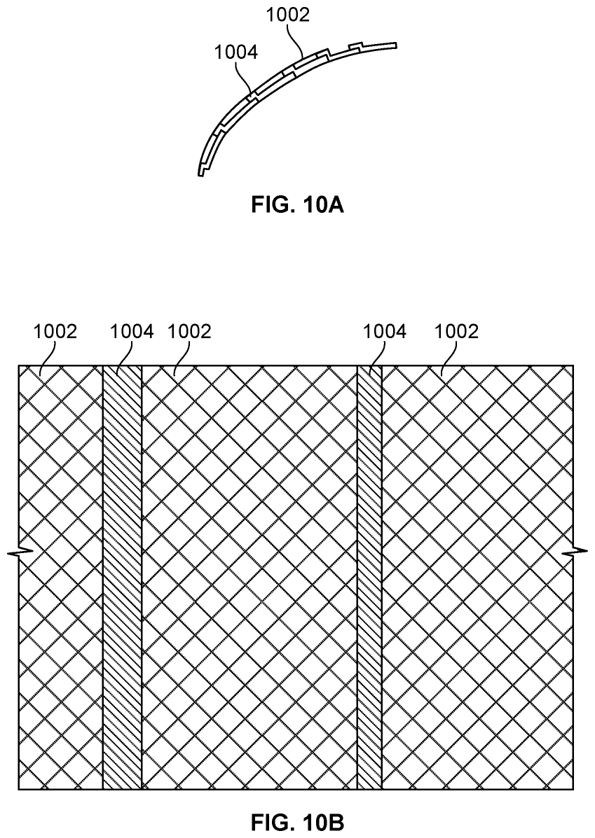

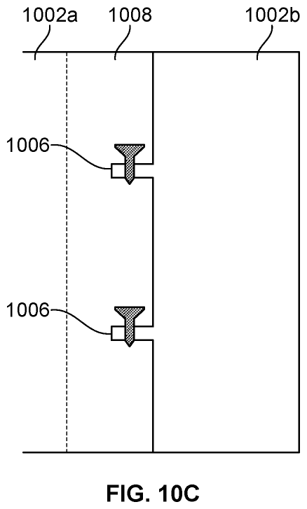

FIG. 10A is a top view of a series of armor panels deployed through a track system to create a bulletproof protection partition, according to an illustrative embodiment, and FIG. 10B is a front view of the series of armor panels of FIG. 10A in a deployed arrangement, according to an illustrative embodiment. In various embodiments, a series of separate armor panels 1002 can be deployed through a track system that can include a floor track and a ceiling track. Each individual armor panel can be deployed separately, and each panel can be nested against the subsequent panel for creating an overlapping armor. Each panel can include an overlap flap 1004 that forms a lap joint over the abutting panel after the panels are slid together on the track. As each panel is slid into place on the track, the overlap flap covers the seam between panels to create a partition without gaps. It should be noted that the individual panels can also be bolted to each other and/or bolted to the floor using mechanical fasteners to create a complete partition. In various embodiments, the last panel to be deployed can be locked in place, thereby holding the previous panels in their positions in the track without needing to lock each panel to the floor or the neighboring plate. An individual armor panel can have many different combinations and configurations of materials. In various embodiments, the armor plate can be made of a combination or layers of Kevlar, ballistic gel, and/or armored steel.

FIG. 10C is a schematic view of a partition formed from bulletproof panels that are hinged together, according to an illustrative embodiment. Turning to FIGS. 10A-C, in various embodiments multiple armored panels 1002 can optionally be hinged together with armored pins 1006 so that they can be moved together. These pins can be armor plated or otherwise hardened. With the armored hinge pins in place, the panels 1002 can be held together and can be moved together. The overlap flap 1004 of panel 1002a overlaps with panel 1002b so that the overlap area 1008 can protect the hinge area.

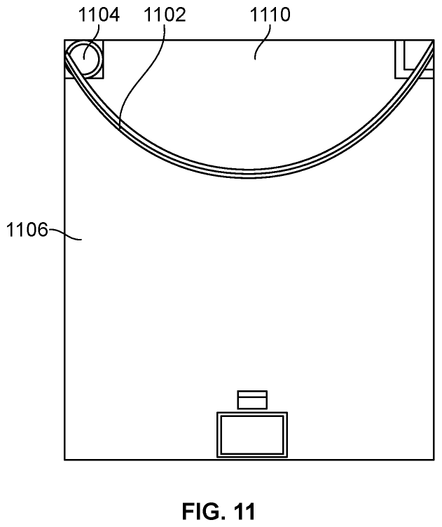

FIG. 11 is a top view showing a bulletproof partition designed to roll and unroll for deployment, according to an illustrative embodiment. The vertical roll partition can be made from flexible materials, including a Kevlar fabric, ballistic gels, etc. The vertical roll partition 1102 can be stored in a coiled or rolled conformation, which can be on a vertical spool 1104, and the partition 1102 can be deployed by unrolling the partition along a track system in the classroom 1106. The partition 1102 can be stored in a roll in a convenient location such as a corner 1104 of the classroom 1106 for easy storage, and can be deployed along the track system to form a safety chamber. In various embodiments, the partition 1102 can form a semi-circular safety chamber 1108, or various shapes according to the shape of the track system. Occupants of the room can move to the protection area 1110, and then can pull the partition around the protection area. The partition can move on the track system in a way that resembles pulling a shower curtain around a shower. The partition 1102 can then be secured to the wall at the end of the track. Although the partition can be flexible, the leading edge of the partition can have a rigid vertical edge that can be secured to the wall to form the safety chamber.

In various embodiments, mobile bulletproof partitions, including vertical roll partitions 1102 can be used to close off the entrance to stores, including stores within a shopping mall. A mobile bulletproof partition used to securely close the entrance to a store to make the store into a safety chamber would also serve the additional function of securing the inside of the store when the store was closed, such as overnight. The mobile bulletproof partition is designed to latch securely to the wall and effectively close off the space so that neither an attacker nor a would-be thief can enter the closed-off space.

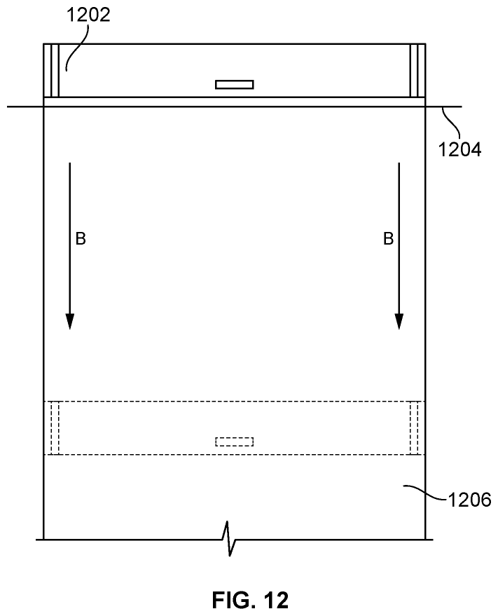

FIG. 12 is a perspective view of a partition that can be stored overhead in ceiling of a classroom, according to an illustrative embodiment. The overhead bulletproof partition can be stored in a overhead horizontal roll, or can be stored in an L-shape track that slides along the ceiling like a conventional garage door. The overhead partition 1202 can be stored in the ceiling 1204, and can be pulled down (shown by arrows “B”) into place over the classroom door 1206 and/or other weak points along the classroom wall such as windows. In various embodiments, the bulletproof partition 1202 can be a sturdy roll-type overhead door, or can be a flexible bulletproof barrier that can be rolled in a horizontal roll, or can be similar to a garage door on an L-shaped track. Similar to the vertical roll bulletproof partition of FIG. 11, various mobile bulletproof partitions, including overhead partitions 1202 can be used to close off the entrance to stores, including stores within a shopping mall. A mobile bulletproof partition used to securely close the entrance to a store to make the store into a safety chamber would also serve the additional function of securing the inside of the store when the store was closed, such as overnight. The mobile bulletproof partition is designed to latch securely in contact with the floor and effectively close off the space so that neither an attacker nor a would-be thief can enter the closed-off space.

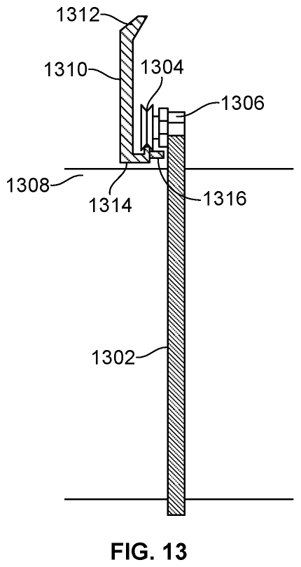

FIG. 13 is an end view showing a slidable partition with ballistic protection for the rails and wheels of the partition, according to an illustrative embodiment. In various embodiments, the partition 1302 can slide out along an overhead rail into a deployed position. In various embodiments, the partition can be used to block a doorway and/or windows to make the entire room a safety chamber, or a partition can be extended across a portion of the room to make a portion of the room into a safety chamber. When faced with a protective partition, a would-be attacker may attempt to shoot at the top end of the partition and the supports holding the partition in place. As shown in FIG. 13, an upper track within the ceiling can include ballistic protection to partition the track and rollers.

The slidable partition 1302 can hang with wheels 1304 on a barn door-type rail 1306 above the ceiling 1308. A ballistic protection/armor plating 1310 protects the rail 1306 and the wheels 1304, so that the shooter cannot shoot the partition off the rails or shoot the rail until it fails. The ballistic protection/armor plating 1310 for the rail 1306 can be attached to the rafters or other structural parts of the building above the ceiling at the top end 1312, and can wrap around to provide complete protection for the rail 1306 and rollers 1304. The lower end of the armor plating for the rail can include a lower end 1314 for protecting the rail 1306 and wheels 1304 from below. A flange 1316 of the armor plating 1310 can also extend from an area under the rail to an area touching or almost touching the side of the partition, so that a shooter cannot shoot at the wheels 1304, the connecting parts between the wheels and the partition, or any other mechanical parts. A slight gap can exist between the flange and the partition so that the partition does not rub against the flange as the partition is moving into the deployed position. The armor plating can extend down from the from rafters, wrap around the rail and wheels, and extend over to the partition. By connecting from the ceiling to the partition, the armor plating helps to provide ballistic protection from the top of the room to the bottom of the room that a shooter cannot shoot above or around. The armor plating can help to protect the occupants of the room from bullets, and can also protect the support system for the partition, so that the partition does not fail.

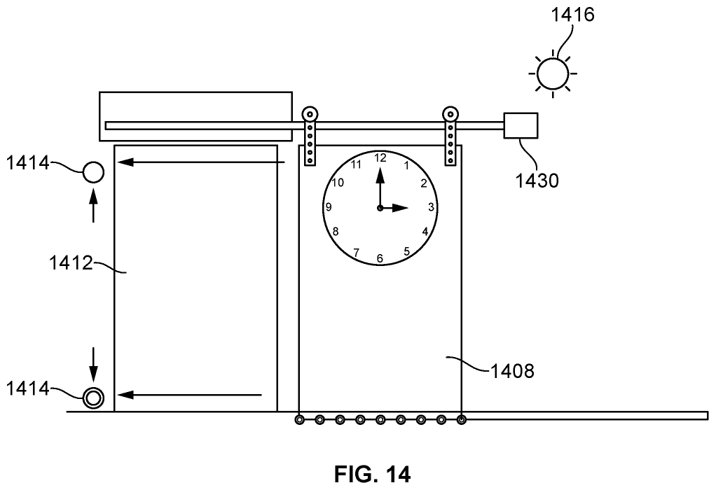

FIG. 14 is an inside view of a security system using a bulletproof partition for securing occupants of a room, according to an illustrative embodiment. In many cases, for safety purposes in the event of a fire or other evacuation, classroom doors typically open outwards from the room towards the hallway. A sliding ballistic door 1408 can slide on an overhead track and/or a floor track to cover the opening of the doorway 1412 from inside, regardless of whether the classroom door is open or closed. In various embodiments, the sliding ballistic door 1408 can be remotely triggered to automatically close entry to the premises such as the classroom. In various embodiments, the system can include an automatic partition mover 1430 that can propel the sliding door 1412. In various embodiments, the sliding door 1412 can be propelled by magnets to close quickly upon the emergence of a threat. In various embodiments, the sliding door 1412 can be propelled by a chain drive, screw drive, or other means.

In various embodiments, the door can be secured in a closed position using electromagnets 1414 that attract corresponding magnets on the door 1408 so that the door cannot easily be pulled open. In various embodiments, the sliding door 1412 can be locked using bolts, such as bolts into the floor and/or bolts into the walls around the door. In various embodiments, the door can be propelled into a closed position and held in a closed position using magnets until bolt locks can be locked to the floor and/or walls. An alert 1416 can provide an audible alarm and/or lights to alert occupants of a threat. In embodiments with an automatic sliding door, the alert 1416 can warn occupants to stand clear of the door as it closes.

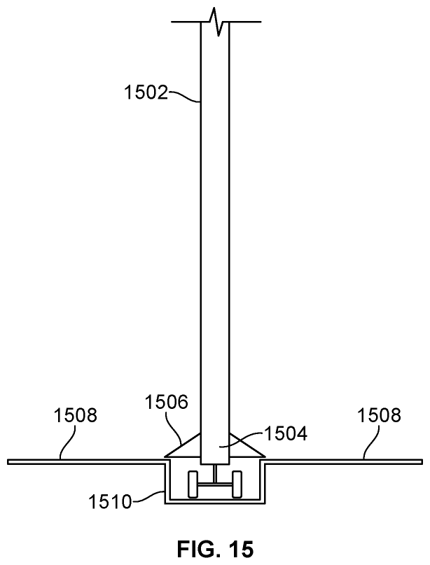

FIG. 15 is an end view of bottom track set into the floor, according to an illustrative embodiment. The panel 1502 of the bulletproof partition can ride on rollers 1504, and the rollers can ride on a track 1510 that can be inset into the floor 1508. A bulletproof kickplate 1506 can protect the rollers 1504 and the track 1510 from bullets. Because the track is inset into the floor, the bottom end of the panel 1502 can be lower than the floor level, as shown in FIG. 15, so a shooter is unable to shoot under the panel and into the safety chamber behind the panel. The kickplate 1506 further protects occupants and prevents bullets from passing under the partition 1502 and into the safety chamber.

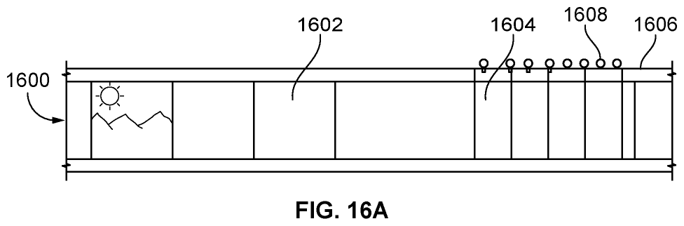

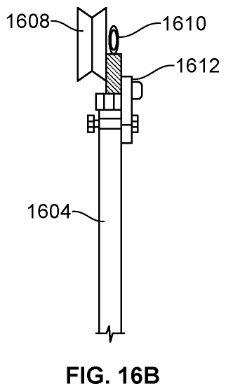

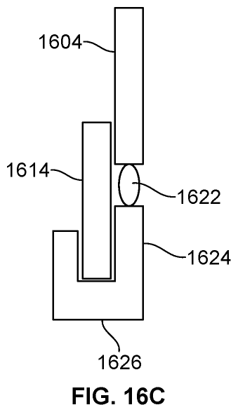

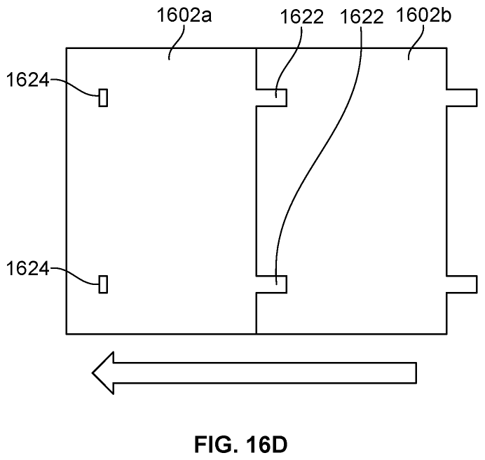

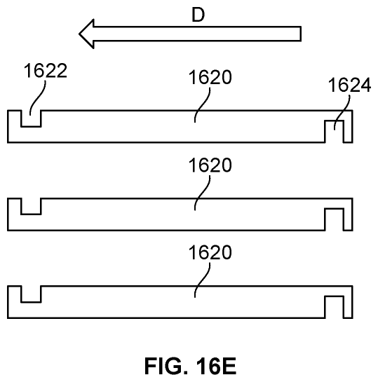

FIG. 16A is an interior view of a protection system for the classroom windows, according to an illustrative embodiment. The window protection system 1600 can include a series of slidable panels 1604 that can slide into place to cover windows 1602. Panels 1602 can have rollers 1608 that travel on an overhead rail 1606, and panels 1602 can have lower rollers that travel on a lower rail. With the weight of the panels supported on the upper and lower rails, even a young child can easily grab the panels and slide the partition over the windows to create a safety chamber within the classroom.

FIG. 16B is a schematic end view of the top portion of a sliding partition that can be used for doorways and windows, according to an illustrative embodiment. Turning to FIGS. 16A and 16B, the rail can be hung high enough above the windows so that the rail and rollers are safely out of the path of any bullets that might come through a window. The partition 1604 can then hang below the rollers 1608 and below the rail 1606, with the bearings 1610 and/or other vulnerable parts facing inwards towards the inside of the room. For sliding partitions that cover doors and windows, the ballistic protection can extend all the way up to the bearings 1610 that connect the rollers 1608 to the panels 1604. With this design, the rail can be mounted flush to the wall, and the panel can hang down from the rail to cover the windows without any gap in protection. In various embodiments, additional ballistic protection 1612 can extend from the rollers 1608 downwards on the inside of the room. This allows the weight of the panel 1604 to hang below the rollers 1608, while also ensuring there is no gap between the rail and the panel that would allow bullets to pass through.

FIG. 16C is a schematic end view of a the bottom portion of a sliding partition for doors and windows, according to an illustrative embodiment. In various embodiments, the lower rollers 1622 can ride on a lower track 1624 that can be at floor level or above floor level. A protective strip 1614 can protect the rollers 1622 at the bottom of the partition, and can protect any gap between the bottom of the partition 1604 and the track 1624. In various embodiments, the protective strip 1614 can be a part of the mobile partition 1604 and can hang down from the partition into recessed groove along the side of the track. In various embodiments, the protective strip 1614 can be a non-mobile part of the track itself, and can extend upwards from the track to cover the lower rollers 1622 and any gap between the partition 1604 and the track 1624.

FIG. 16D is an interior view of a stackable panel, according to an illustrative embodiment, and FIG. 16E is a top view of the stackable panels of FIG. 16D, according to an illustrative embodiment. In various embodiments, stackable panels 1602 can be stored together with each panel in an upright position ready to be deployed, and with multiple panels aligned with one in front of the other. Stackable panels 1620 can be stored within a shoe or holding area at the end of the track system. As each panel 1620 is pulled down the track system in the direction of arrow D, the teeth 1622 of the leading panel can bite into the pit 1624 of the next panel. In that way, as each panel is deployed onto the track to cover a window or wall, the next panel can be automatically engaged by the panel before it, thereby pulling the next panel down the track. As the teeth of one panel engage the pit of the next, each panel is engaged by the panel before it until a connected series of panels has formed a partition over the windows and/or wall.

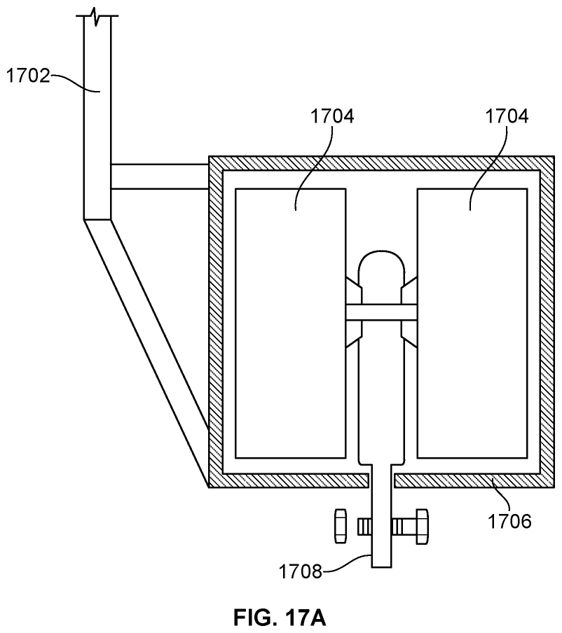

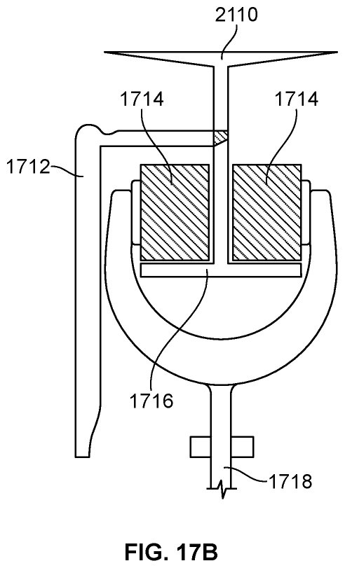

FIG. 17A is a partially cut away view showing rollers riding within an enclosed overhead tube-type rail according to an illustrative embodiment. In various embodiments, the partition can be supported at the top end by an upper rail with a tube-like structure. Rollers 1704 can roll within the tube 1706. The bulletproof partition can be attached to tab 1708 to hang below the rollers and the tube. The tube can be made of a hardened material, such as a steel, to protect the rollers from bullets.

In various embodiments, an upper rail can have a bulwark 1702 that can provide ballistic protection to the rail and rollers. Various upper rails can include a bulwark to protect the rail and rollers, including tube-type and non-tube-type upper rails. The bulwark 1702 can be angled to deflect bullets and protect the upper mechanical workings of the mobile partition. The bulwark 1702 can shield the rail, the rollers, and the top of the partition from bullets.

FIG. 17B is a partially cut away view showing rollers riding on a T-type or I-beam-type rail according to an illustrative embodiment. Rollers 1714 can roll along rail 1716 to deploy a mobile bulletproof partition that can hang from tab 1718. Bulwark 1712 can wrap around to cover the rail 1716 and rollers 1714. Bulwark 1712 can extend along the length of the rail to protect the rail and rollers from bullets, and the bulwark 1712 can hang down lower than the rail and rollers to provide additional protection. The bulwark provides ballistic protection for the rail and rollers and for the occupants of the safety chamber, without interfering with the operation of the moving partition. In various embodiments, the bulwark 1712 can extend to the right, as shown in FIG. 17B, to meet the partition to create a seamless protection. In various embodiments, the bulwark nearly meets the partition, although a slight gap can exist between the bulwark and the partition so that the partition does not rub on the bulwark as the partition is being moved into the deployed position. In various embodiments, the gap can be less than one inch.

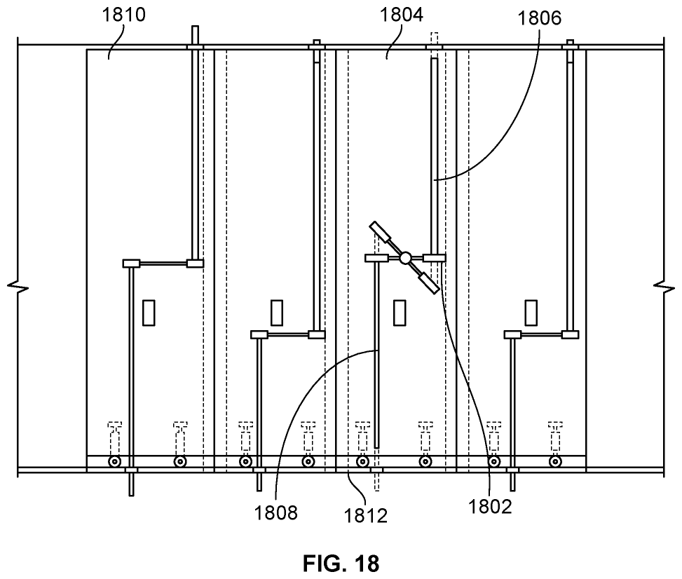

FIG. 18 is a perspective view from within the safety chamber showing vertical-bolt locking mechanisms to secure the mobile partition in a desired location, according to an illustrative embodiment. Locking vertical bars can be driven into bolt holes to lock the partition in a deployed position so that it cannot be moved by an assailant. A locking handle 1802 can be positioned on the inside of each panel 1804 and the locking handle 1802 can rotate, for example, counter clockwise to drive the upper bars 1806 into an upper locking bolt receptacle 1810 that can be in the upper rail or other upper area, and drive lower bars 1808 into a lower locking bolt receptacle 1812 that can be in the floor or lower track. The locking handle 1802 can rotate clockwise to pull the vertical bars 1806, 1808 out from the locking bolt receptacles 1810, 1012 so the partition can be moved. It should be clear that the direction of rotation could be changed without departing from the present disclosure. In various embodiments, a single vertical bolt locking mechanism can secure the entire partition in the deployed position, however, multiple locking mechanisms can be provided, optionally including one or more locking mechanism per panel of the partition.

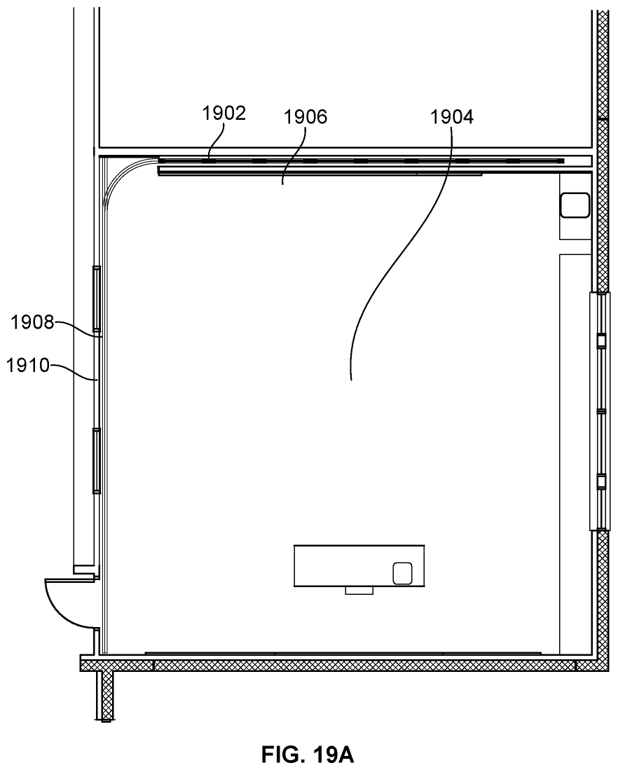

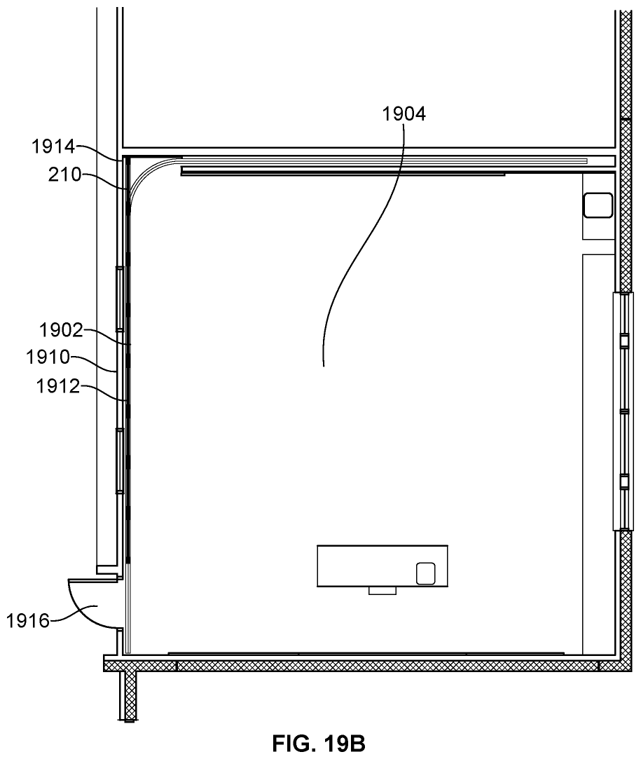

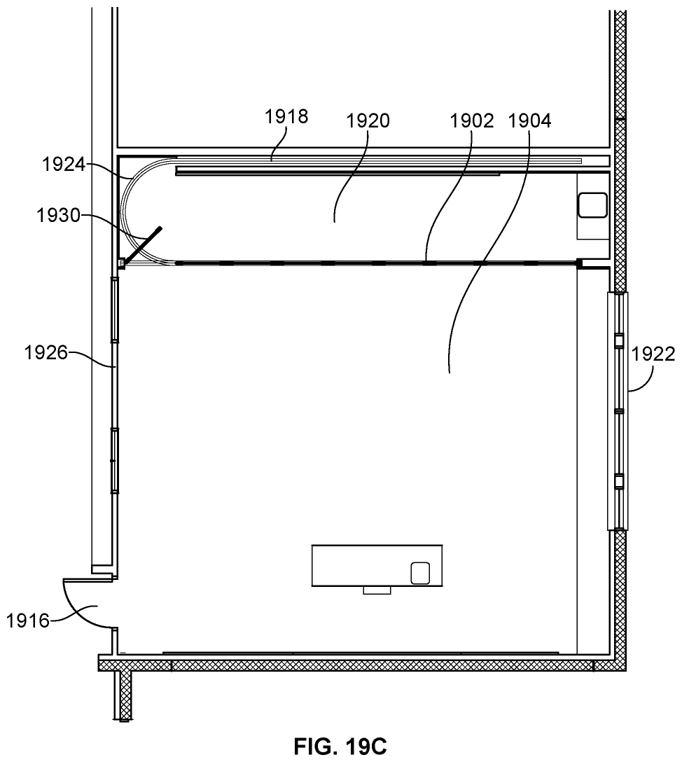

FIG. 19A is a top view showing the layout of a classroom with a mobile bulletproof partition designed to slide on floor track and ceiling track, according to an illustrative embodiment. A floor track can be inset into the floor of a classroom and/or a ceiling track can be a loadbearing track in the ceiling. The track 1908 can be arranged in an L-shape so that the mobile partition can be stored along one wall and deployed along a second wall to seal off the room and form a safety chamber within the room. As illustrated, the partition 1902 can be stored behind a false wall 1906 of the classroom 1904. The optional false wall 1906 can hide the mobile partition to reduce the appearance of ballistic materials within the room, but is not critical to the functioning of the partition. When an attack occurs, the partition can be pulled out along the track to cover the doors and/or windows of a soft wall 1910.

FIG. 19B is a top view showing the layout of a classroom with a mobile bulletproof partition in a partially deployed position, according to an illustrative embodiment. The partition 1902 can be pushed along the track 1912 to cover all or a portion of the soft wall 1910. In various embodiments, the mobile partition 1902 can be rolled back through the switch junction 210 to be locked in place with a latch 1914 that can be at the end of the track. In various embodiments, the mobile partition can extend to cover the door 1916 and can be locked in place to prevent entry, even if the door 1916 is open. In various embodiments, the class door can be a ballistic door that can be locked in place and can prevent entry of intruders and can stop bullets. In embodiments with a locking ballistic class door, the mobile partition need not extend to cover the door 1916. In various embodiments without a ballistic class door, the mobile partition can extend to cover an entire soft wall 1910 and can be locked in place at either end, both ends, or along the length of the wall.

FIG. 19C is a top view showing the layout of a classroom with a mobile bulletproof partition creating a reduced-space safety chamber in a subset of the classroom, according to an illustrative embodiment. The mobile partition can be deployed along track 1924 to create a reduced-space safety chamber 1920 in a subset of the classroom 1904. In various embodiments, a reduced space safety chamber in a subset of the room may be preferable to installing a protective partition over the soft interior wall 1910 and another protective partition over the windows 1922 of the exterior wall. In various embodiments, when the partition 1902 is locked in place in the fully deployed position, as shown in FIG. 19C, a gap 1928 can remain between the trailing edge of the ballistic panel 1902 and wall 1926. This gap 1928 can be used as an opening to enter and exit the safety chamber 1920. In various embodiments, a hinged ballistic panel 1930 that can be pivotably hinged to wall 1926 can be used to close the gap. In various embodiments with a hinged ballistic panel 1930, a switch junction can be unnecessary. In other embodiments, at least a portion of the partition 1902 may have the capacity to fold in a fan or accordion style, so that the trailing edge can pass beyond the switch junction and then can be extended to meet the wall 1926. In various embodiments, the classroom door 1916 can also be a locking ballistic door that can provide a second level of security.

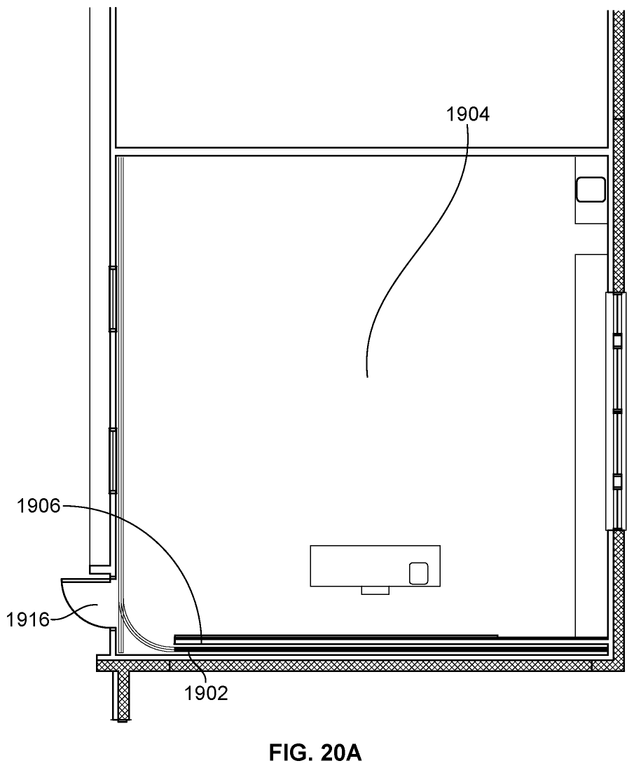

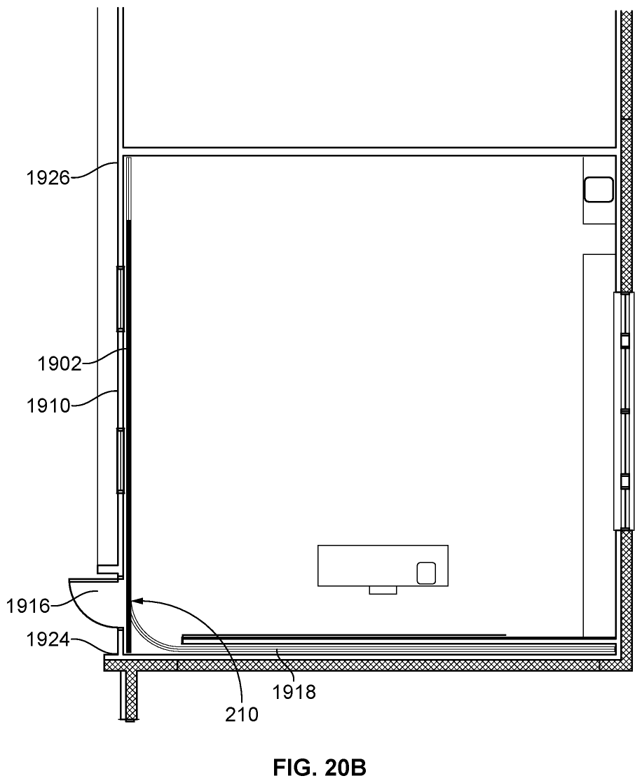

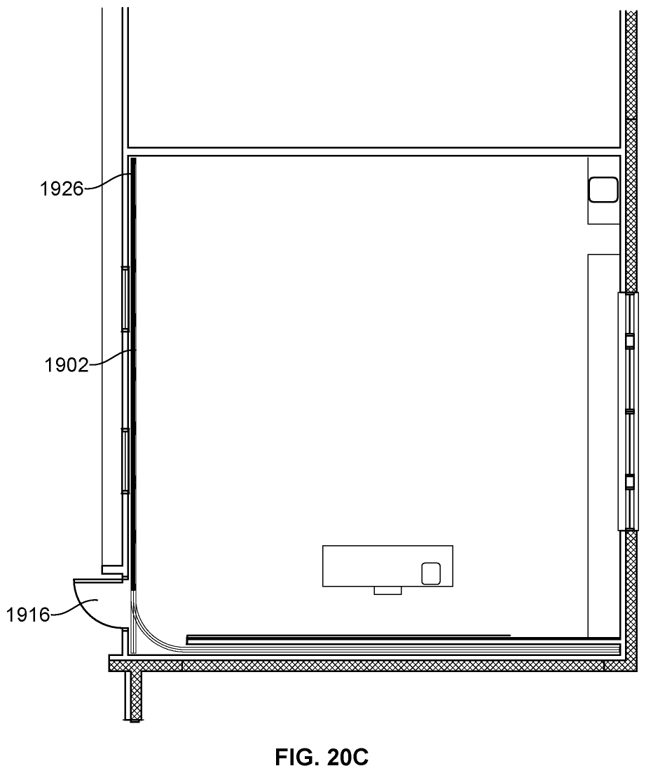

FIG. 20A is a top view showing the layout of a classroom with a mobile bulletproof partition stored at the front of the classroom, according to an illustrative embodiment. False wall 1906 can be at the front of the classroom and can hold chalkboards, etc. The partition 1902 can be stored behind the false wall 1906 on L-shaped track 1912. In the event of an attack, the partition can be deployed along track 1912 to cover soft interior wall 1910, including covering the doorway 1916 and any interior windows that face out to the hallway. In various embodiments, the partition 1902 can roll back through a switch junction, or the door can be a ballistic door, or various other options as provided throughout this disclosure.

FIG. 20B is a top view showing the layout of a classroom with a mobile bulletproof partition in a deployed position, according to an illustrative embodiment. The mobile bulletproof partition 1902 can be deployed along the soft wall 1910, and can be rolled back through the switch junction to the corner of the room where it can safely cover the doorway and block entry. A stub wall 1926 with a ballistic panel can protect the end of the soft wall so that the entire wall can be a ballistic partition, despite the mobile partition covering less than the entire soft wall. A locking bolt 1924 can lock the mobile partition into the desired location covering the doorway 1916.

FIG. 20C is a top view showing the layout of a classroom with a mobile bulletproof partition in a deployed position with a ballistic classroom door, according to an illustrative embodiment. In various embodiments, the partition 1902 can be deployed to cover less than all of the soft interior wall 1910. A ballistic door and door frame can protect the doorway, and the mobile panel can be deployed to cover the rest of the soft interior wall.

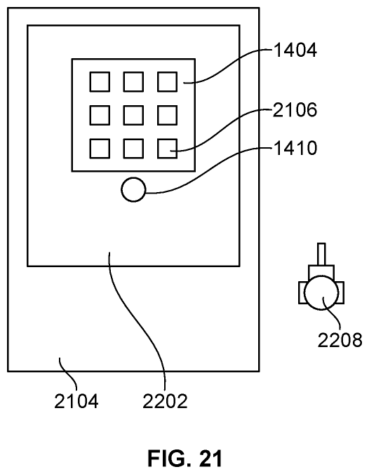

FIG. 21 is a schematic view of a security room for the bulletproof protection system. In various embodiments, a camera system can monitor in and around a school for possible threats. A remote monitoring room 2204 can allow one computer system and/or one monitoring officer to look for incoming threats at any number of schools in a school district, any number of different office buildings, shopping malls, etc. In various embodiments, one or more monitors 1404 can show one or more feeds 2206 from different schools and/or other buildings. Cameras 2208 can be positioned on the outside of a school watching the approaches to the school, and the camera feeds can watch for individuals with hostile intentions approaching a school. In various embodiments, human monitors and/or AI technology can be used to watch for individuals carrying weapons towards any one school. Upon perceiving a threat, the human monitor and/or the AI monitor can send an action signal to the school that is being threatened. Cameras 2208 can also be placed within the school to monitor for hostile activity already occurring within the building.

In various embodiments, the monitoring room 2204 may be within the school, with one human monitor and/or one electronic monitoring system per school, or the monitoring room can be remote with several schools being monitored by the same monitoring system. In various embodiments, the monitoring system may take place entirely online or within a cloud system, with no actual physical monitoring room 2204. The monitor can be a human monitor and/or an electronic monitor.

The monitor can perceive a threat, and then the monitor can send an action signal to the threatened school. The action signal can cause the school to enter a threatened status. The action signal can cause automatic doors to close and lock at the entrance to the school. The action signal can cause automatic bulletproof classroom doors to close automatically at each classroom. The action signal can cause automatic hallway doors to close automatically. The action signal can cause various partitions to deploy automatically, or to begin to deploy automatically. In various embodiments, the partitions can be deployed a first few inches automatically by magnetic force, piston force, or other means of force when the monitor sends an action signal. In various embodiments, a partition can be completely obscured behind the false wall until the action signal is received, and then the action signal can trigger the piston, magnet, or other motive force to move the partition at least a few inches out from behind the false wall, so that it can be easily grasped and moved into a fully-deployed conformation. The action signal can also trigger an alert that can include a siren, flashing lights, etc. The students, staff, and others can finish deploying the partition, if the partition is not fully deployed automatically, and can then safely stay within the safety chamber.

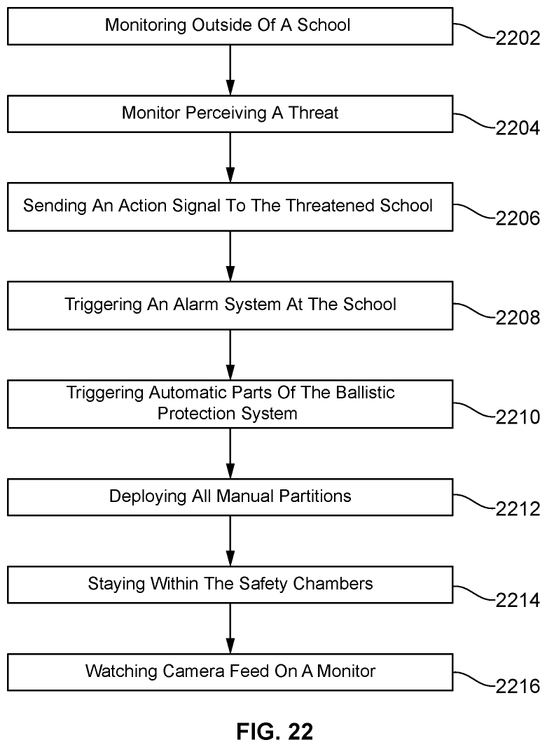

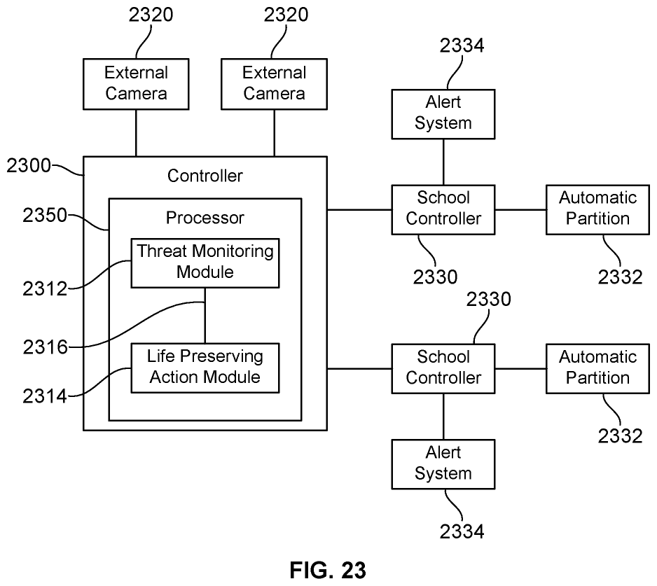

FIG. 22 is a flow chart showing a method of protecting a school or other building, according to an illustrative embodiment. At box 2202, a monitor can monitor the outside of a school. The monitor can be a human monitor, an electronic monitor, including an AI monitoring system, or a combination of a human working with an electronic monitoring system. At box 2204, the monitor can perceive a threat such as a hostile individual approaching the school with a weapon. At box 2206, the monitor can send an action signal to the threatened school. In various embodiments, the monitor may be located at the threatened school or may be remote from the threatened school. At box 2208, the action signal can trigger an alarm system at the school. The alarm signal can alert occupants of the building to the threat. At box 2210, the action signal can trigger automatic parts of the ballistic protection system, including an automatic sliding ballistic door that can slide into place automatically to cover the school entrance doors and classroom doors to protect the occupants. The action signal can trigger all automatic components of the ballistic protection system, including partitions that can be slid into place to cover a wall or doorway, and/or can be slid into place to create a safety chamber. The action signal can trigger automatic partitions that can begin to move automatically, so that they emerge from behind a false wall far enough for a child to grab the partition and move it along the tracks. At box 2212, the occupants of the room can deploy all manual partitions, including partitions that have automatically deployed a portion of the way and need the occupants to complete the deployment. At box 2214, the occupants can stay within the safety chambers that have been created and wait for help to arrive. At box 2216, the occupants of the safety chamber can watch a TV monitor showing the feed from the camera outside, so that the occupants of the safety chamber can see help arriving to the school.

FIG. 23 is a schematic overview of a processing and control system for an automatic threat detection and ballistic protection system, according to an illustrative embodiment. The controller 2300 can monitor threats and take action to preserve the lives of threatened individuals such as students in a threatened school. The controller 2300 includes a processor 2310, and processor 2310 can have a threat monitoring module 2312. The threat monitoring module can receive inputs from an external camera 2320, and the threat monitoring module can monitor camera signals for indications of a hostile individual approaching a school with a weapon. External cameras can be placed outside of a school, monitoring the outside of the school, and/or inside monitored areas within the school. The controller can have a life-preserving action module 2314. The threat monitoring module can send a signal to the life preserving action module 2314 indicating that there is a threat. A buss 2316 can connect various modules and components so that signals can be passed from one to another. The life preserving action module can send a signal to the school controller 2330. The school controller 2330 can send a signal to automatic partitions 2332 directing the automatic partitions to close, or partially close. The school controller can send a signal to the alert system 2334 directing the alert system to signal to the occupants of the school that a threat has been detected. The alert system 2334 can include visible lights and auditory indicators of a threat. Note that the above-described processes/ors and/or modules are exemplary of a variety of control and feedback architectures that can be implemented in various embodiments to perform the desired functions described herein. Alternate implementations should be clear to those of skill.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

The bulletproof protective system described herein can be adapted for use in nearly any environment in any types of schools, homes and businesses. It should be clear that the partitions described herein can be of any suitable size and configuration as is known in the art without affecting the overall concept of the invention, provided that it accomplishes the above stated objectives. One of ordinary skill in the art will appreciate that the bulletproof system shown in the figures are for illustrative purposes only, and that many other sizes and shapes of the bulletproof system are well within the scope of the present disclosure. Although the dimensions of the bulletproof system are important design parameters for user convenience, the bulletproof system may be of any size that ensures optimal performance during use and/or that suits the user's needs and/or preferences.

The terms bulletproof and ballistic are used herein to describe systems and materials that are designed to prevent bullets from passing through the described systems and materials. Nearly all materials will eventually fail in the face of prolonged onslaughts, heavy artillery, etc., however, the terms such as bulletproof and ballistic protection are intended to be used here as they are used in common usage, meaning that they are effectively bullet resistant for at least some predetermined amount of time or shots. The size of ammunition, the number of shots, and other factors can all effect how long the systems described herein can remain bulletproof. However, the systems and methods described herein are intended to be bulletproof as that word is understood by one skilled in the art. The systems and methods described herein are designed to provide at least level III protection. Similarly, various locking mechanisms described herein as keeping an attacker out may not be impenetrable forever in the face of prolonged onslaughts, heavy equipment, etc., however, the locking mechanisms described herein are designed to be impenetrable for some predetermined period of time that can be at least until help can arrive. The locking mechanisms described herein are designed to withstand attacks without heavy equipment for at least as long as the longest school attacks currently on record.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. Also, as used herein, various directional and orientational terms (and grammatical variations thereof) such as “vertical”, “horizontal”, “up”, “down”, “bottom”, “top”, “side”, “front”, “rear”, “left”, “right”, “forward”, “rearward”, and the like, are used only as relative conventions and not as absolute orientations with respect to a fixed coordinate system, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances (e.g. 1-2%) of the system. Note also, as used herein the terms “process” and/or “processor” should be taken broadly to include a variety of electronic hardware and/or software based functions and components. Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Accordingly, this description is meant to be taken only by way of example, and not to otherwise limit the scope of this invention.

What is claimed is:

1. A mobile ballistic partition system for deployment in a school or other building, the mobile ballistic partition system comprising:
at least one mobile ballistic panel,
at least one roller on the mobile ballistic panel,
at least one locking mechanism configured to selectively lock the mobile ballistic panel to a wall or floor to secure the mobile ballistic panel in a deployed position, thereby creating an enclosed safety chamber within a room.

2. The mobile ballistic partition system of claim 1, further comprising at least one track that is in a fixed location within a room, the at least one track defining the area of the safety chamber, wherein the roller on the at least one mobile ballistic panel can travel along the track so that the mobile ballistic panel defines the enclosed safety chamber.

3. The mobile ballistic partition system of claim 2, wherein the at least one track is inset into the floor a predetermined distance, so that the bottom edge of the mobile ballistic partition is below the floor surface thereby creating a safety chamber that is free from gaps between the mobile ballistic partition and the ceiling that would allow a shooter to shoot into the safety chamber.

4. The mobile ballistic partition system of claim 3, wherein the at least one partition further comprises a kickplate at the bottom of the partition, the kickplate extending out from the partition to cover the track that is inset into the floor, the kickplate configured to deflect bullets so that bullets cannot be shot at the rollers or the track.

5. The mobile ballistic partition system of claim 2, wherein the at least one track is an overhead rail that is inset into the ceiling a predetermined distance, so that the top edge of the mobile ballistic partition is above the ceiling thereby creating a safety chamber that is free from gaps between the mobile ballistic partition and the ceiling that would allow a shooter to shoot into the safety chamber.

6. The mobile ballistic partition of claim 5, wherein the overhead rail further includes a bulwark, the bulwark extending from above the rail and the at least one roller to below the rail and the at least one roller, and the bulwark extending to less than an inch from the mobile ballistic partition when the mobile ballistic partition is in a deployed conformation.

7. The mobile ballistic partition of claim 1, wherein the at least one roller further includes a height adjustor, wherein when the height adjustor is in an extended conformation the roller at least partially extends below the bottom of the mobile ballistic panel so that the mobile ballistic panel can be moved into a deployed position, and wherein when the height adjustor is in a retracted conformation the roller does not extend below the bottom of the mobile ballistic panel so that the bottom of the mobile ballistic panel rests on the floor.

8. The mobile ballistic partition of claim 2, wherein the at least one mobile ballistic panel further comprises a plurality of mobile ballistic panels that are arranged in a row, and wherein the mobile ballistic partition further comprises hinges between adjacent panels so that two neighboring panels can pivot relative to each other, wherein the mobile ballistic partition that comprises a plurality of mobile ballistic panels can be deployed along the track to create a protective wall that defines a safety chamber.

9. The mobile ballistic partition of claim 8, wherein at least one of the plurality of mobile ballistic panels has a seam overlap flap at one end of the panel, and a notch at the other end of the panel, so that when the panels pivot relative to each other to form a wall, the seam overlap flap of one panel will lay in the notch of the neighboring panel, so that the seam overlap flap creates a ballistic protection for the hinges between panels.

10. The mobile ballistic partition of claim 1, wherein the at least one mobile ballistic panel includes at least two mobile ballistic panels, wherein the two mobile ballistic panels are hinged to one or more walls of a room at proximal ends of the mobile ballistic panels, and wherein the mobile ballistic panels are hinged to the one or more walls of the room at locations that are remote from each other, and wherein the two mobile panels can be stored along one or more walls in the stored conformation, and wherein the two mobile panels can be hingedly pivoted out from the walls, and wherein the mobile ballistic panels can meet at distal ends of the panels to form a safety chamber with mobile panels forming at least two walls of a safety chamber, the safety chamber including at least one wall of the building as a wall of the safety chamber.

11. A system for preserving human life during an armed attack, the system comprising:
at least one camera facing an outside of a building,
at least one monitor monitoring a video stream from the camera,
at least one mobile ballistic partition within the building, the mobile ballistic partition stored in a stored conformation, and
at least one automatic partition mover operatively connected to the at least one mobile ballistic partition,
wherein the at least one mobile ballistic partition is automatically moved to an at least partially deployed conformation by the automatic partition mover in response to an action signal from the monitor.

12. The system for preserving human life of claim 11, further comprising at least one overhead rail to support the at least one mobile ballistic partition, wherein the at least one mobile ballistic partition further comprises at least one roller that rolls on the overhead rail to carry the mobile ballistic partition, and wherein the at least one overhead rail further comprises a bulwark to shield the rail, the roller, and the top of the partition from bullets.

13. The system for preserving human life of claim 11, further comprising at least one lower track that is inset into the floor, wherein the at least one mobile ballistic partition further comprises at least one roller that rolls on the lower track to carry the mobile ballistic partition, wherein the bottom edge of the mobile ballistic partition is below the floor surface so that there are no gaps to allow a shooter to shoot into the safety chamber.

14. The system for preserving human life of claim 11, wherein the at least one mobile ballistic partition is concealed behind a false wall when the at least one mobile ballistic partition is in a stored position, and wherein when the at least one automatic partition mover automatically moves the at least one mobile ballistic partition in response to an action signal, the at least one mobile ballistic partition is at least partially exposed by pushing the at least one mobile ballistic partition out from behind the false wall so that it can be grabbed by a person and fully deployed manually.

15. A method of preserving human life, the method comprising:
monitoring the outside of a building,
perceiving a threatening individual approaching the building,
sending an action signal to the threatened building,
alerting occupants of the building to the threat in response to the action signal,
automatically moving automatic parts of a ballistic protection system in response to the action signal.

16. The method of claim 15, wherein automatically moving automatic parts of the ballistic protection system in response to the signal further comprises moving parts of the ballistic protection system to form a safety chamber, the safety chamber configured to provide a ballistic shelter to preserve the lives of the occupants of the safety chamber.
